(19) United States
(12) Patent Application Publication
(10) Pub. No.: US 2016/0311182 A1
(43) Pub. Date: Oct. 27, 2016

(54) USE OF OPTICALLY CLEAR ADHESIVES AS SKINS TO DELIVER FLOWABLE HOT MELT LIQUID OPTICALLY CLEAR ADHESIVES

(71) Applicant: 3M INNOVATIVE PROPERTIES COMPANY, St. Paul, MN (US)

(72) Inventors: Audrey A. Sherman, Woodbury, MN (US); Margot A. Branigan, Roseville, MN (US); Lyudmila A. Pekurovsky, Bloomington, MN (US); Kevin R. Schaffer, Woodbury, MN (US); Joshua P. Weinberg, Brookings, SD (US); Robert R. Kieschke, Woodbury, MN (US)

(21) Appl. No.: 14/691,696

(22) Filed: Apr. 21, 2015

(51) Int. Cl. B29C 70/84; B29C 70/88; C09J 7/00

(52) U.S. Cl. CPC B29C 70/84; C09J 7/00; B29C 70/88; C09J 2201/606; C09J 2203/318; B29K 2023/083

(57) ABSTRACT

The present invention is a layered optically clear adhesive including a first pressure-sensitive optically clear adhesive, a second pressure-sensitive optically clear adhesive, and a flowable optically clear adhesive positioned between the first and the second pressure-sensitive optically clear adhesives.

### FIELD OF THE ART

The present invention is related generally to a layered optically clear adhesive. In particular, the present invention is related to a layered optically clear adhesive for use with ink steps.

### BACKGROUND

Compared to traditional optically clear adhesive (OCA) films, liquid optically clear adhesives (LOCAs) photocurable optically clear adhesives (PCOCAs) may be able to provide thinner gaps, increased control over thickness, decreased stress from lamination, and increased accommodations to the various features of a display assembly, such as ink steps. Therefore, LOCAs and PCOCAs are becoming more prevalent in the display industry to fill the air gap between layers, for example, between the coverglass and ITO touch sensors, between ITO touch sensors and liquid crystal modules, or directly between the coverglass and the liquid crystal module.

The display industry is currently moving toward liquid crystal module (LCM) bonding. LCM bonding requires a low shrinkage and low modulus material for optical performance and LCM bonding. Furthermore, it is also critical to ensure that the bonding adhesive does not have a deleterious effect on the LCM's appearance (e.g. mura effect, optical defects, etc.), has high adhesion, and is optically reliable under environmental testing conditions such as at about 85° C. and about 65° C. at 90% relative humidity (RH).

Many current LOCA and PCOCA products are predominantly prepared from acrylic monomers or reactive oligomers based on acrylic monomers. However, these monomers and oligomers may have either significant shrinkage that may be detrimental for LCM bonding or require further optimizations. Polyurethane acrylate based oligomers are also used in LOCA and PCOCA materials to achieve high adhesion, low shrinkage and low modulus LCM bonding. However, these oligomers often require a relatively high concentration of polar monomers, such as 4-hydroxybutyl acrylate, in order to achieve coatable viscosity and optical reliability under environmental aging conditions, which typically require more than 800 hours of optical stability at about 85° C. and about 65° C./90% RH. Using high levels of diluents monomer directly contributes to the shrinkage of the adhesive upon cure and can offset the benefit of using polyurethane acrylate oligomers.

### SUMMARY

In one embodiment, the present invention is a layered optically clear adhesive including a first pressure-sensitive optically clear adhesive, a second pressure-sensitive optically clear adhesive, and a flowable optically clear adhesive positioned between the first and the second pressure-sensitive optically clear adhesives.

In another embodiment, the present invention is a display assembly including a first substrate, a second substrate, a multilayer optically clear adhesive positioned between the first and the second substrates, and an ink step positioned between the first and the second substrates, wherein a portion of the multilayer optically clear adhesive is adjacent the ink step. The multilayer optically clear adhesive includes a first pressure-sensitive adhesive, a second pressure-sensitive adhesive, and a flowable optically clear adhesive positioned between the first and the second pressure-sensitive optically clear adhesive.

In yet another embodiment, the present invention is a method of filling a gap within a display assembly. The method includes first providing a first substrate and a second substrate, wherein at least one of the first substrate and the second substrate includes a topographical feature. The method then includes positioning a layered optically clear adhesive between the first substrate and the second substrate. The layered optically clear adhesive includes a first pressure-sensitive adhesive, a second pressure-sensitive adhesive, and a flowable optically clear adhesive positioned between the first and the second pressure-sensitive optically clear adhesive. Next, the method includes heating the layered optically clear adhesive to a melt temperature of the flowable optically clear adhesive, and applying pressure to at least one of the first and the second substrates to cause the flowable optically clear adhesive to flow from between the first and the second pressure sensitive optically clear adhesives and fill a gap created by the topographical feature.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

These figures are not drawn to scale and are intended merely for illustrative purposes.

FIG. 1 is an enlarged, cross-sectional view of the layered optically clear adhesive of the present invention.

FIG. 2 is a cross-sectional view of the layered optically clear adhesive positioned within a display assembly.

FIG. 3 is a cross-sectional view of a first embodiment of a display assembly using the layered optically clear adhesive of the present invention.

FIG. 3A is a cross-sectional view of a second embodiment of a display assembly using the layered optically clear adhesive of the present invention.

### DETAILED DESCRIPTION

The present invention is a layered optically clear adhesive (OCA) that can be used as a pressure sensitive adhesive to bond to a substrate as well as a flowable adhesive to fill gaps. For example, the layered OCA can be used to flow under ink steps of display assemblies. Using optically clear pressure sensitive adhesives as a delivery system for flowable OCAs enables simple assembly of a display assembly that does not require the use of dispensing machines and reduces both the time and cost associated with dispensing machines.

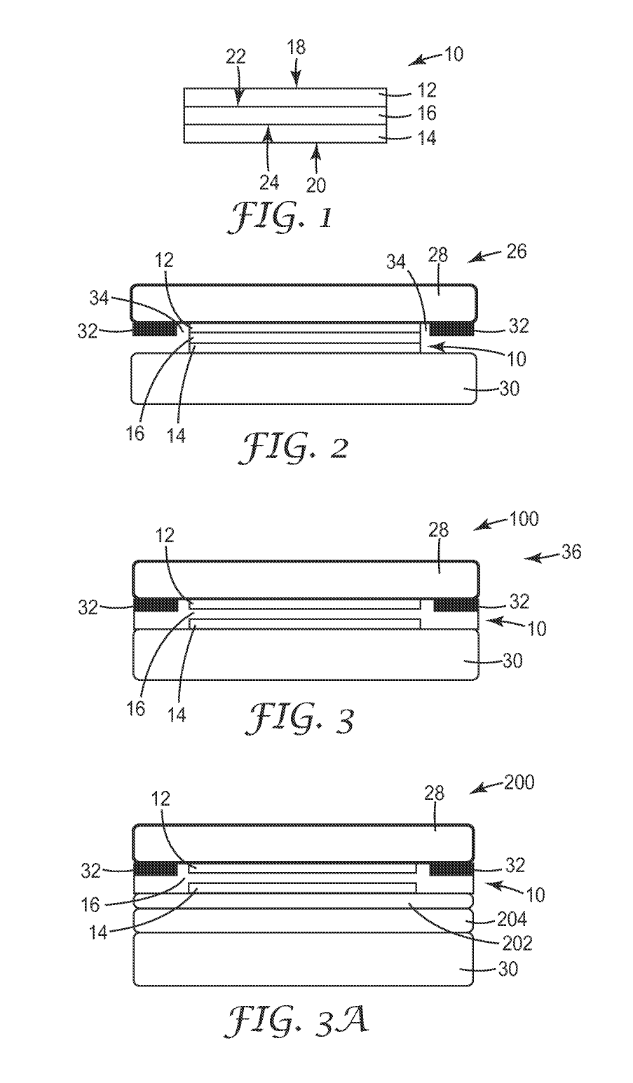

FIG. 1 shows an enlarged, cross-sectional view of the layered OCA 10 of the present invention. The layered OCA 10 includes a first pressure sensitive OCA 12, a second pressure sensitive OCA 14, and a flowable optically clear adhesive 16 positioned between the first and second pressure sensitive OCAs 12, 14. As used herein, the term “optically clear” refers to a material that has a luminous transmission of greater than about 90 percent, a haze of less than about 2 percent, and opacity of less than about 1 percent in the 400 to 700 nm wavelength range. Both the luminous transmission and the haze can be determined using, for example, ASTM-D 1003-95. Typically, the optically clear adhesives are visually free of bubbles.

The first and second pressure sensitive OCAs 12, 14 are pressure sensitive adhesives (PSAs) that each includes a first major surface 18, 20 and an opposite, second major surface 22, 24, respectively. Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power.

Useful PSAs include those based on natural rubbers, synthetic rubbers, styrene block copolymers, (meth)acrylic block copolymers, polyvinyl ethers, polyolefins, thermoplastic elastomers, tackified thermoplastic-epoxy derivatives, polyurethane derivatives, polyurethane acrylate derivatives, silicone PSAs such as polydiorganosiloxanes, polydiorganosiloxane polyoxamides and silicone urea block copolymers, and poly(meth)acrylates. As used herein, (meth)acrylic refers to both acrylic and methacrylic species and likewise for (meth)acrylate.

In some embodiments, at least one of the PSAs can include one or more additives such as nanoparticles, plasticizers, chain transfer agents, initiators, antioxidants, stabilizers, viscosity modifying agents, and antistats.

In one embodiment, at least one of the PSAs may include a microstructured adhesive surface to allow for air bleed upon application to the surface of the substrate as described, for example, in U.S. 2007/0212535 (Sherman et al.).

In one embodiment, at least one of the PSAs includes a stretch releasable PSA. Stretch releasable PSAs are PSAs that can be removed from a substrate if they are stretched at or nearly at a zero degree angle. Stretch releasable PSAs may be used if disassembling, reworking, or recycling is desired.

In one embodiment, at least one of the PSAs includes a clear acrylic PSA, for example, those available as transfer tapes such as VHB Acrylic Tape 4910F and 4918 from 3M Company, and 3M Optically Clear Laminating Adhesives (8140 and 8180 series).

Examples of useful PSAs are described in detail in International Publication No. WO2010/005655 A2 (Sherman et al.). Another exemplary PSA comprises a non-silicone urethane-based adhesive as described in International Publication No. WO2010/132176 (Sherman et al.). Additional exemplary PSAs include tackified thermoplastic epoxies as described in U.S. Pat. No. 7,005,394 (Ylitalo et al.), polyurethanes as described in U.S. Pat. No. 3,718,712 (Tushaus), and polyurethane acrylates as described in US 2006/0216523 (Shusuke).

In one embodiment, the first and second pressure sensitive OCAs 12, 14 include the same composition. In another embodiment, the first and second pressure sensitive OCAs 12, 14 include different compositions. When the first and second pressure sensitive OCAs 12, 14 include different compositions, this allows for other means to tailor parameters such as refractive index or peel strength. This may allow for easy lamination or air bleed lamination. In addition, the thickness of the first and second pressure sensitive OCAs 12, 14 may be the same or different, also allowing for varying flow or peel force.

The flowable OCA 16 is positioned between the first and second pressure sensitive OCAs 12, 14 and may be any OCA that is flowable. Flowable OCAs can be melted at low temperatures and caused to flow. Suitable flowable OCAs include liquid optically clear adhesives (LOCAs), photocurable optically clear adhesives (PCOCAs), optically clear hot melt adhesives and heat activated optically clear adhesives (HOCAs).

Being a liquid, LOCAs flow very well and can thus successfully fill in gaps. Examples of suitable LOCAs include those described in WO 2013/049133 with an international publication date of Apr. 4, 2013 titled: METHOD OF COATING LIQUID OPTICALLY CLEAR ADHESIVES ONTO RIGID SUBSTRATES and WO 2013/181030 with an international publication date of Dec. 5, 2013 titled: LIQUID OPTICAL ADHESIVE COMPOSITIONS, both of which are hereby incorporated by reference.

Photocurable adhesives generally are adhesives that can melt at low temperatures and are flowable until cured. Examples of suitable photocurable adhesive include those described in U.S. patent application Ser. No. 13/122,521 filed May 12, 2011, titled: PHOTOCURABLE ADHESIVE COMPOSITION.

Hot melt adhesive generally have a low glass transition temperature and a relatively high melt temperature. Examples of suitable hot melt adhesives include those described in U.S. Pat. No. 5,006,582 filed Mar. 31, 1989, titled: ACRYLIC HOLT MELT PRESSURE SENSITIVE ADHESIVE COMPOSITIONS.

At room temperature, the HOCA has the shape and dimensional stability of a fully cured optically clear adhesive film and can be die cut and laminated as a dry film. With very moderate heat and/or pressure, the HOCA will flow to completely wet out a substrate without creating excessive force on the substrate that may cause it to dimensionally deform, and any remaining stresses in the adhesive can be relaxed prior to the part being finished. Examples of suitable HOCAs include those described in U.S. Patent Application No. 61/311,961 filed Mar. 9, 2010 titled: HEAT ACTIVATED OPTICALLY CLEAR ADHESIVE FOR BONDING DISPLAY PANELS, which is hereby incorporated by reference.

In one embodiment, the flowable OCA 16 may also be a flowable film adhesive. A suitable flowable film adhesive can be applied and handled as a film but upon heating to relatively low temperature (at most 85° C.), the film softens and conforms to the structures on the surface and then cures to form an adhesive layer that has the desirable structural integrity and durability to withstand the use demands described above. Examples of suitable flowable film adhesive include those disclosed in pending U.S. Patent Application Ser. No. 62/046,324 filed Sep. 5, 2014, titled: HEAT CONFORMABLE ADHESIVE FILMS, which is hereby incorporated by reference.

FIG. 2 is a cross-sectional view of the layered optically clear adhesive 10 initially positioned within a display assembly 26. The display assembly 26 includes a first substrate 28 and a second substrate 30 with the layered OCA 10 positioned between the first and second substrates 28, 30. The first and second pressure sensitive OCA layers 12, 14 are used to bond the first and the second substrates 28, 30 together. The layered OCA 10 is used to deliver the flowable OCA 16 into gaps created by topographical features 32 within the display assembly. For example, the flowable OCA 16 can be used to fill in the area under an ink step. It is common for newer designs using cover glasses to have a thick (approaching 50 micrometers) ink step around the perimeter or frame of the cover glass, generating a substrate that is no longer flat but has a third dimension to it (i.e. the optically clear adhesive has to conform to significant differences in the z-dimension of the cover lens substrate). The region encompassed by the ink step is often referred to as a gap. In one embodiment, at least one of the first and second substrates 28, 30 includes a feature 32 that creates topography and resulting gap 34, such as an ink step.

A wide variety of substrates are suitable as the first or second substrate 28, 30. The substrates 28, 30 may be a rigid substrate or a non-rigid substrate. Examples of rigid substrates include glass plates, relatively thick polymeric plates such as polymethyl methacrylate (PMMA) plates and polycarbonate (PC) plates, and the exterior surface of devices. Examples of suitable non-rigid substrates include polymeric films. Examples of polymeric films include films comprising one or more polymers such as cellulose acetate butyrate; cellulose acetate propionate; cellulose triacetate; poly(meth)acrylates such as polymethyl methacrylate; polyesters such as polyethylene terephthalate, and polyethylene naphthalate; copolymers or blends based on naphthalene dicarboxylic acids; polyether sulfones; polyurethanes; polycarbonates; polyvinyl chloride; syndiotactic polystyrene; cyclic olefin copolymers; and polyolefins including polyethylene and polypropylene such as cast and biaxially oriented polypropylene.

One particularly suitable class of film substrates for use in the present invention are optical films. As used herein, the term “optical film” refers to a film that can be used to produce an optical effect. The optical films are typically polymer-containing films that can be a single layer or multiple layers. The optical films can be of any suitable thickness. The optical films often are at least partially transmissive, reflective, antireflective, polarizing, optically clear, or diffusive with respect to some wavelengths of the electromagnetic spectrum (e.g., wavelengths in the visible ultraviolet, or infrared regions of the electromagnetic spectrum). Exemplary optical films include, but are not limited to, visible mirror films, color mirror films, solar reflective films, diffusive films, infrared reflective films, ultraviolet reflective films, reflective polarizer films such as brightness enhancement films and dual brightness enhancement films, absorptive polarizer films, optically clear films, tinted films, dyed films, privacy films such as light-collimating films, and antireflective films, antiglare films, soil resistant films, anti-fingerprint films, touchsensors, electrical films, transparent shielding films, backlight films and the like.

In one embodiment, one or both of the substrates 28, 30 may be substantially transparent. For example, the substrates 28, 30 and the layered OCA 10 may be used in display panels or touch panels. Examples of substrates may include, but are not limited to: display panels, substantially transparent substrates and touch-sensitive substrates.

Examples of display panels include, but are not limited to: liquid crystal displays (LCDs), light-emitting diodes (LEDs), plasma display panels, and electrophoretic displays.

Examples of substantially transparent substrates can include a glass or a polymer. Useful glasses can include borosilicate, soda lime, and other glasses suitable for use in display applications as protective covers. Useful polymers include polyester films such as polyethylene terephthalate, polycarbonate films or plates, acrylic films such as polymethylmethacrylate films, cycloolefin polymer films, and silicone and urethane based films. The substantially transparent substrate typically has an index of refraction close to that of display panel and/or the adhesive layer; for example, from about 1.4 and about 1.7.

A touch panel is a transparent thin film-shaped device and when a user touches or presses a position on the touch panel with a finger or a pen, the position can be detected and specified. Touch-sensitive optical assemblies (touch-sensitive panels) can include capacitive sensors, resistive sensors, and projected capacitive sensors. Such sensors include transparent conductive elements on substantially transparent substrates that overlay the display.

In use, the layered OCA 10 is positioned between the first and second substrates 28, 30 to form a laminate 36. If at least one of the substrates 28, 30 includes topographical features 32, the layered OCA 10 is positioned between the topographical features 32. Once the layered OCA 10 is positioned between the substrates 28, 30, heat is applied as well as pressure to at least one of the first and second substrates 28, 30 to bring the first and second substrates 28 and 30 together to form the laminate 36. Heating of the layered OCA 10 often requires moderate temperatures to avoid damage to the display components. The layered OCA 10 is heated to the melt temperature of the flowable OCA 16 and pressure is applied to the laminate 34 to cause compression of the first and second pressure sensitive OCAs 12, 14. The melt temperature of a flowable OCA is the temperature at or above which the flowable OCA 16 is softened or flows to sufficiently fill a gap or conform to a topographical feature. The melt temperature may be a temperature at or above which a phase transition such as crystalline melt has occurred, or may be a temperature at which the viscosity has been sufficiently reduced to permit flow under the desired application conditions. An OCA at or above a melt temperature may be described as melted. As the first and second pressure sensitive OCAs 12, 14 are compressed, the flowable OCA 16 flows from between the first and second pressure sensitive OCAs 12, 14. The flowable OCA 16 flows into the display assembly 26 and conforms to the topographical features 32, filling in any gaps 34, as shown in FIG. 3. This method of filling in gaps 34 removes dragging force and allows for the flowable adhesive 16 to flow into the gap and under the topographical features 32.

The heating step can be performed using a convection oven, a hot plate, a heat laminator, an autoclave or the like. In order to promote flowing of the flowable OCA 16 and allow the flowable OCA 16 to more efficiently conform to a topographical feature 32, it is preferred to apply a pressure simultaneously with heating by using a heat laminator, an autoclave or the like. The heating temperature of the flowable OCA 16 may be a temperature at which the flowable OCA 16 is softened or flows to sufficiently conform to a topographical feature, and the heating temperature can be generally 30° C. or more, 40° C. or more, or 60° C. or more, and 150° C. or less, 130° C. or less, or 110° C. or less. In the case of pressurizing the HOCA, the pressure applied can be generally 0.05 MPa or more, particularly 0.1 MPa or more, and 2 MPa or less, particularly 1 MPa or less.

After the flowable OCA 16 has flowed into the desired gaps 34, the layered OCA 16 may be cured, forming a laminate within a display assembly. Curing may be effected in a variety of ways. Typically the initiator or initiators are activated by exposure to light of the appropriate wavelength and intensity. Often UV light is used. The layered OCA 16 can thus be cured by exposure to UV light generated by any suitable source such as UV lamps. Often articles are cured by UV light by passing the article to be cured beneath a bank of UV lamps through the use of conveyor belt or other similar conveyance. In some embodiments, only photocuring is used to fully cure the flowable OCA 16, but in some embodiments it may be desirable to use optional thermal curing as well. If optional thermal curing is to be used, the heat can be supplied in a variety of ways through the use of an IR lamp, by placing the article in an oven, or by using an autoclave.

FIG. 3 is a cross-sectional view of a first embodiment of a display assembly 100 with the layered optically clear adhesive 10 of the present invention. As can be seen, the layered OCA 10 is positioned between the first substrate 28 and the second substrate 30. The first pressure sensitive OCA 12 is positioned adjacent the first substrate 28 and positioned between the topographical features 32. The second pressure sensitive OCA 14 is positioned adjacent the second substrate 30. The flowable OCA 16 is also positioned between the topographical features 32 as well as under the topographical features 32 and around the second pressure sensitive OCA 12, filling in where there were gaps below the topographical features 32. Although FIG. 3 depicts the first and second pressure sensitive OCAs 12 and 14 as having the same width after assembly of the display assembly 100 as before assembly of the display assembly (FIG. 2), either one or both of the first and second pressure sensitive OCAs 12, 14 may flatten out and widen as the first substrate 28 and the second substrate 30 are brought together to form a laminate. In the embodiment shown in FIG. 3, the first substrate 28 is a cover glass, or window, and the second substrate 30 is a LCD module. However, the first and second substrates 28, 30 may be any substrate without departing from the intended scope of the present invention.

FIG. 3A is a cross-sectional view of a second embodiment of a display assembly 200 using the layered optically clear adhesive 10 of the present invention. In the second embodiment, the layered OCA 10 is positioned between a first substrate 28 and a second substrate 30 of the display assembly 200, but the display assembly 200 also includes an indium-tin oxide (ITO) layer 202. The layered OCA 10 of the second embodiment of the display assembly 200 functions similarly to the first embodiment of the display assembly 100 except that the second pressure sensitive adhesive 14 is positioned adjacent the ITO layer 202. A separate optically clear adhesive layer 204 then adheres the ITO layer 202 to the second substrate 30. The separate optically clear adhesive layer 204 may be a layered OCA, a pressure sensitive OCA or a flowable OCA without departing from the intended scope of the present invention.

### Examples

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

TABLE 1
Sources of Materials

| Trade Designation | Composition | Available From |
|---|---|---|
| Elvax 410 | Ethylene vinyl | DuPont, Wilmington, DE USA |
| | acetate polymer | |
| Evatane 33400 | Ethylene vinyl | Arkema, Colombes, France |
| | acetate polymer | |
| Scotchweld 3792 | Ethylene vinyl | 3M Company, St. Paul, MN, |
| | acetate polymer | USA |
| Optically Clear | Acrylic PSA | 3M Company, St. Paul, MN, |
| Adhesive 8146-4 | | USA |
| Optically Clear | Acrylic PSA | 3M Company, St. Paul, MN, |
| Adhesive 8171 | | USA |
| Dynacoll 7111 | Polyester polyol | Evonik, Leverkusen, Germany |
| Desmophen C2200 | Polycarbonate | Bayer Materials, |
| | polyol | Leverkusen, Germany |

### Testing Procedures

### Total Transmission and Haze (ASTM D1003)

Luminous transmission, clarity and haze were measured according to ASTM D1003-00 using a Gardner Haze-Guard Plus model 4725 (available from BYK-Gardner Columbia, Md.). The adhesive was sandwiched between 2 films (as noted in the Example section) and percent transmission, percent haze, and percent clarity values were recorded. The results are presented in Table 2.

### Adhesive Displacement

The flowing adhesive laminate (prepared as described below) was cut into a square, approximately 1.5 inches by 1.5 inches. It was placed between two glass microscope slides and the border of the laminate sample was traced on the upper glass surface with a black marker. Two aluminum plates were preheated in an oven at 185° C. Each plate weighed 1174 grams. The prepared sample was placed in the oven between the two aluminum plates. The sample had an oven residence time of five minutes and then removed. The results are recorded in Table 3, including whether the adhesive displacement was beyond the marked black border of the original sample.

### Preparation of Flowing Adhesive Laminates

Samples of ethylene vinyl acetate adhesives (flowing adhesive) were pressed between 4 mil thick pieces of 8146-4 acrylic adhesive or between 1 mil thick pieces of 8171 acrylic adhesive (skin materials), as indicated in Table 2, using a Carver Lab Press, Model M, manufactured by Fred Carver Inc., Menomonee Falls, Wis., USA.

Polyols were also used as flowing adhesives. Polyols were coated using 0.5 mil Bird Film Applicators (available from Bird Film Applicator, Inc., Norfolk, Va.) at 125° C. on 8171 adhesive. A second piece of 8171 adhesive was laminated on top of the applied polyol coating to form a laminated sample.

TABLE 2
Optical Testing

| | Hot Melt | | | |
|---|---|---|---|---|
| Laminate construction | Adhesive | | | Average |
| (skin material/ | Thickness | Average % | Average % | % |
| flowing adhesive) | (mils) | Transmission | Haze | Clarity |
| 2 layers 8146-4/ | 15.5 | 93.90 | 1.68 | 97.73 |
| Elvax 410 | | | | |
| 2 layers 8146-4/ | 21.7 | 93.90 | 7.51 | 99.00 |
| Evatane 33400 | | | | |
| 2 layers 8146-4/ | 15.8 | 89.97 | 20.53 | 94.77 |
| Scotchweld 3792 | | | | |
| 2 layers 8171/ | — | 93.63 | 1.36 | 98.87 |
| Dynacoll 7111 | | | | |

TABLE 3
Adhesive Displacement Testing

| Laminate construction | | |
|---|---|---|
| (skin material/ | Hot Melt Adhesive | Adhesive |
| flowing adhesive) | Thickness (mils) | Displacement |
| 2 layers 8146-4/ | 19 | Yes |
| Elvax 410 | | |
| 2 layers 8146-4/ | 15.8 | Yes |
| Evatane 33400 | | |
| 2 layers 8146-4/ | 7 | Yes |
| Scotchweld 3792 | | |
| 2 layers 8171/ | 24.8 | Yes |
| Dynacoll 7111 | | |
| 2 layers 8171/ | 8.7 | Yes |
| Desmophen C2220 | | |

Although the present invention has been described with reference to preferred embodiments, workers skilled in the art will recognize that changes may be made in form and detail without departing from the spirit and scope of the invention.

What is claimed is:

1. A layered optically clear adhesive comprising:
a first pressure-sensitive optically clear adhesive;
a second pressure-sensitive optically clear adhesive; and
a flowable optically clear adhesive positioned between the first and the second pressure-sensitive optically clear adhesives.

2. The layered optically clear adhesive of claim 1, wherein the first pressure-sensitive optically clear adhesive and the second-pressure sensitive optically clear adhesive are composed of the same material.

3. The layered optically clear adhesive of claim 1, wherein the first pressure-sensitive optically clear adhesive and the second-pressure sensitive optically clear adhesive are composed of different materials.

4. The layered optically clear adhesive of claim 1, wherein the flowable optically clear adhesive is one of a liquid optically clear adhesive, a photo-curable optically clear adhesive, a optically clear hot melt adhesive and a heat activated optically clear adhesive.

5. The layered optically clear adhesive of claim 1, wherein the flowable optically clear adhesive has a melt temperature of less than about 110° C.

6. A display assembly comprising:
a first substrate;
a second substrate;
a multilayer optically clear adhesive positioned between the first and the second substrates, wherein the multilayer optically clear adhesive comprises:
a first pressure-sensitive adhesive;
a second pressure-sensitive adhesive; and
a flowable optically clear adhesive positioned between the first and the second pressure-sensitive optically clear adhesive; and
an ink step positioned between the first and the second substrates, wherein a portion of the multilayer optically clear adhesive is adjacent the ink step.

7. The display assembly of claim 6, wherein at least one of the first and the second substrates is substantially transparent.

8. The display assembly of claim 6, wherein the first pressure-sensitive optically clear adhesive and the second-pressure sensitive optically clear adhesive are composed of the same material.

9. The display assembly of claim 6, wherein the first pressure-sensitive optically clear adhesive and the second-pressure sensitive optically clear adhesive are composed of different materials.

10. The display assembly of claim 6, wherein the flowable optically clear adhesive is one of a liquid optically clear adhesive, a photo-curable optically clear adhesive, a optically clear hot melt adhesive and a heat activated optically clear adhesive.

11. The display assembly of claim 6, wherein the flowable optically clear adhesive has a melt temperature of less than about 110° C.

12. A method of filling a gap within a display assembly, the method comprising:
providing a first substrate and a second substrate, wherein at least one of the first substrate and the second substrate includes a topographical feature;
positioning a layered optically clear adhesive between the first substrate and the second substrate, wherein the layered optically clear adhesive comprises:
a first pressure-sensitive adhesive;
a second pressure-sensitive adhesive; and
a flowable optically clear adhesive positioned between the first and the second pressure-sensitive optically clear adhesive;
heating the layered optically clear adhesive to a melt temperature of the flowable optically clear adhesive; and
applying pressure to at least one of the first and the second substrates to cause the flowable optically clear adhesive to flow from between the first and the second pressure sensitive optically clear adhesives and fill a gap created by the topographical feature.

13. The method of claim 12, further comprising curing the layered optically clear adhesive.

14. The method of claim 12, wherein at least one of the first and the second substrates is substantially transparent.

15. The method of claim 12, wherein the first pressure-sensitive optically clear adhesive and the second-pressure sensitive optically clear adhesive are composed of the same material.

16. The method of claim 12, wherein the first pressure-sensitive optically clear adhesive and the second-pressure sensitive optically clear adhesive are composed of different materials.

17. The method of claim 12, wherein the flowable optically clear adhesive is one of a liquid optically clear adhesive, a photo-curable optically clear adhesive, a optically clear hot melt adhesive and a heat activated optically clear adhesive.

18. The method of claim 12, wherein heating the layered optically clear adhesive to a melt temperature of the flowable optically clear adhesive comprises heating to a temperature of less than about 110° C.

19. The method of claim 12, wherein applying pressure to at least one of the first and the second substrates comprising applying about 0.05 MPa of pressure.
